(19) United States
(12) Patent Application Publication
(10) Pub. No.: US 2017/0151042 A1
(43) Pub. Date: Jun. 1, 2017

(54) FLOSS THREADER

(71) Applicant: HARJEET SANDHU, Surrey (CA)

(72) Inventor: HARJEET SANDHU, Surrey (CA)

(21) Appl. No.: 14/953,279

(22) Filed: Nov. 27, 2015

(51) Int. Cl. A61C 15/04; B29C 41/46; B29C 41/14; B29C 65/70; B29C 45/14

(52) U.S. Cl. CPC A61C 15/045; B29C 65/70; B29C 45/14467; B29C 41/14; B29C 41/46; B29L 2031/753

(57) ABSTRACT

A dental floss threader adapted to minimize discomfort of the user comprising: a shank extending between a first end and second and being elastically deformable; an eyelet integrally joined at said first end of said shank; and a covering enclosing said second end of said shank.

### BACKGROUND

1. Field

The present disclosure generally relates to dental flossing instruments and more particularly dental floss threaders enabled with a discomfort minimizing feature.

2.Description of Related Prior Art

U.S. Pat. No. 3,929,144 discloses a device for inserting dental floss through interproximal areas and method of using same. A device for inserting dental floss in difficult-to-reach areas under dental bridges or splints, comprising a length of flexible material formed into a loop, the ends of which are bonded together over a substantial portion to provide a stiffened elongated guide portion. The floss is threaded through the loop and the device, with the guide portion leading, is passed under two connected teeth of a bridge through interproximal areas whereby the floss is inserted through such areas.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Disclosed is a dental floss threader adapted to minimize discomfort of the user comprising: a shank extending between a first end and second and being elastically deformable; an eyelet integrally joined at said first end of said shank; and a covering enclosing said second end of said shank.

### BRIEF DESCRIPTION OF THE DRAWINGS

The detailed description set forth below references the following drawings:

FIGS. 1a and 1b are dental floss threaders incorporating exemplary embodiments of the present disclosure;

FIGS. 2a, 2b, 2c, and 2d together is an injection molding process for making adapted floss threaders.

FIGS. 3a, 3b, and 3c together is a dip-forming process for making adapted floss threaders.

FIGS. 4a and 4b together is a method of use of an adapted floss threader while FIG. 4c provides illustration of an alternative method of use.

### DETAILED DESCRIPTION

Oftentimes those that require the use of a floss threader to complete the dental flossing process suffer from sensitive gums and teeth. The floss threaders in the prior art contain sharp ends which can cause discomfort to the user during use when the sharp end comes in contact with the sensitive region in the mouth. Due to the fact that the floss threader must be used several times during each flossing session, once in between each set of teeth, the flossing experience can be painful owing to the sharp threader tip and can even lead to the user avoiding the use of floss altogether. The present disclosure, as demonstrated by the exemplary embodiment(s) described below, can minimize discomfort due to the floss threader tip in the mouth of the user during prescribed use.

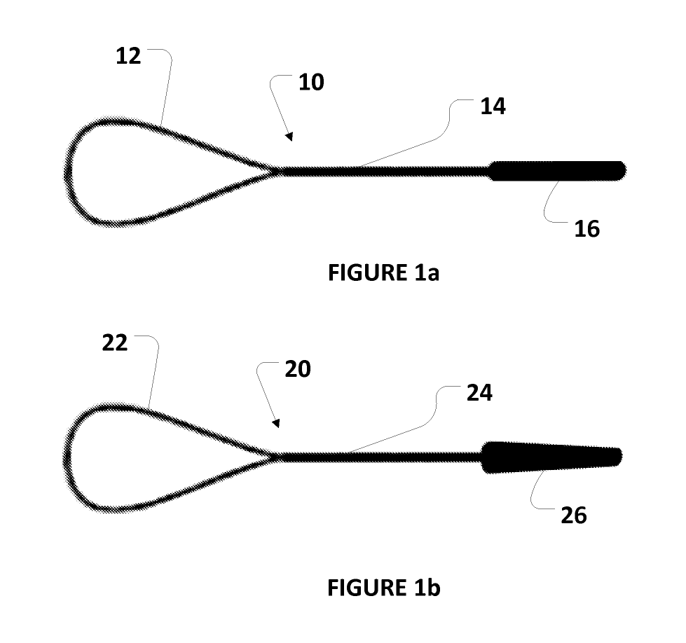

Referring to FIG. 1a, floss threader 10 has eyelet 12, shank 14, and covering 16 wherein covering 16 is applied in order to soften the tip of shank 14 such that when placed in the mouth, the otherwise sharp end of shank 14 does not cause discomfort to the user. In this embodiment the covering 16 is of relatively consistent diameter and is of a size that approximately doubles the diameter of shaft 14 although the diameter can be larger but preferably less than six times the diameter of shaft 14. The shank 14 can be less than 0.5 millimeter in diameter. Shank 14 and eyelet 12 can be constructed of an elastically deformable material with similar rigidity or shank 14 can have a different level of rigidity than eyelet 12. Furthermore, the covering 16 can act to cover a part of shaft 14 or can cover the entire length of shaft 14. Shaft 14, covering 16, and eyelet 12 can also be coated with one or more of a flavoring agent, a colorant, and an antibacterial agent.

Similarly, in FIG. 1b, floss threader 20 has eyelet 22, shank 24, and covering 26 wherein covering 26 takes on a slightly conical shape, having a changing diameter along its length. As one skilled in the art would recognize, the cross sectional shape of the covering can vary widely while still providing the discomfort minimizing function.

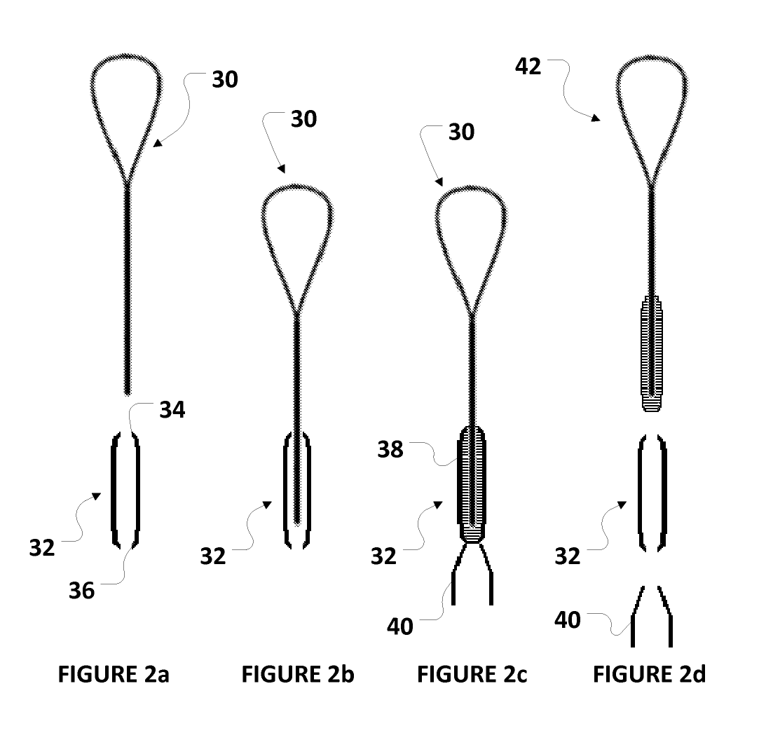

Now in reference to FIG. 2a, a floss threader 30 is presented to a mold 32 having both a floss entrance hole 34 and a gate 36 wherein the gate is enabled to receive molten material injected into the mold by a nozzle. In FIG. 2b, the floss threader 30 has been positioned inside mold 32. In FIG. 2c, the floss threader 30 remains inside mold 32 while nozzle 40 is positioned to inject material 38 into the mold 32 thereby overmolding a portion of floss threader 30. In FIG. 2d, the injection molding process is completed when the nozzle 40 disengages and adapted floss threader 42 is removed from mold 32. The injected material 38 in FIG. 2c can be silicone wherein the material is injected at a relatively low temperature into a relatively hot mold 32 wherein the material is vulcanized. Injected material 38 could also be latex.

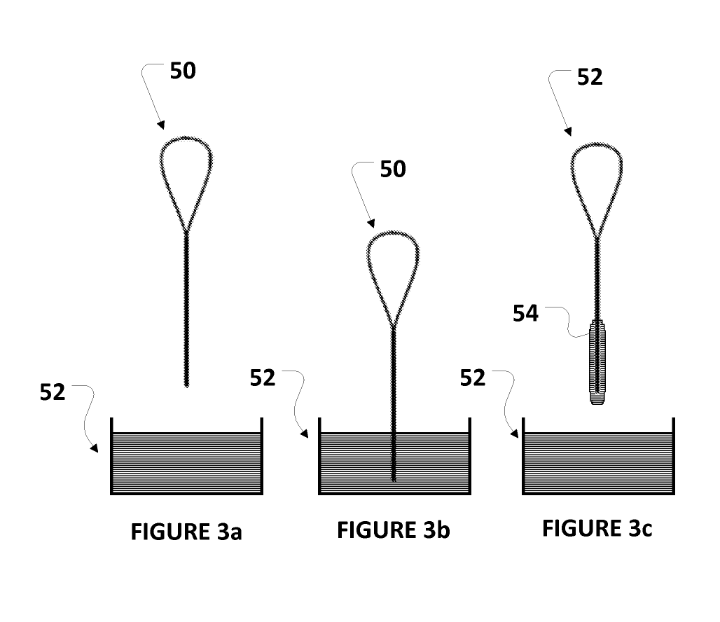

Moving now to a dip coating process as described in FIGS. 3a, 3b, and 3c. In FIG. 3a, floss threader 50 is presented to a fluid bath 52. One skilled in the art would recognize that floss threader 50 is required to be clean and in some cases primed and heated to ensure adherence of the coating in the process prior to the dipping as pictured in FIG. 3b. Here, threader 50 is dipped into fluid bath 52 for some finite time. In FIG. 3c, the adapted floss threader 52 is removed from the fluid bath 52 and coating 54 is permitted to cure. The curing could include heating induced vulcanizing, cooling induced hardening, or a solvent evaporation process. One skilled in the art would recognize that fluid bath 52 could contain wax or one of several dip coating plastics including latex, neoprene, and plastisol. Fluid bath 52 could contain the same or similar wax regularly used to coat dental floss. In this case the dip coating process may need to be repeated to build up sufficient thickness of a coating necessary to provide the minimizing discomfort feature. Furthermore, one would recognize that any coating, whether dip coated or injection molded, could contain one or more of a flavoring agent, a colorant, and an antibacterial agent.

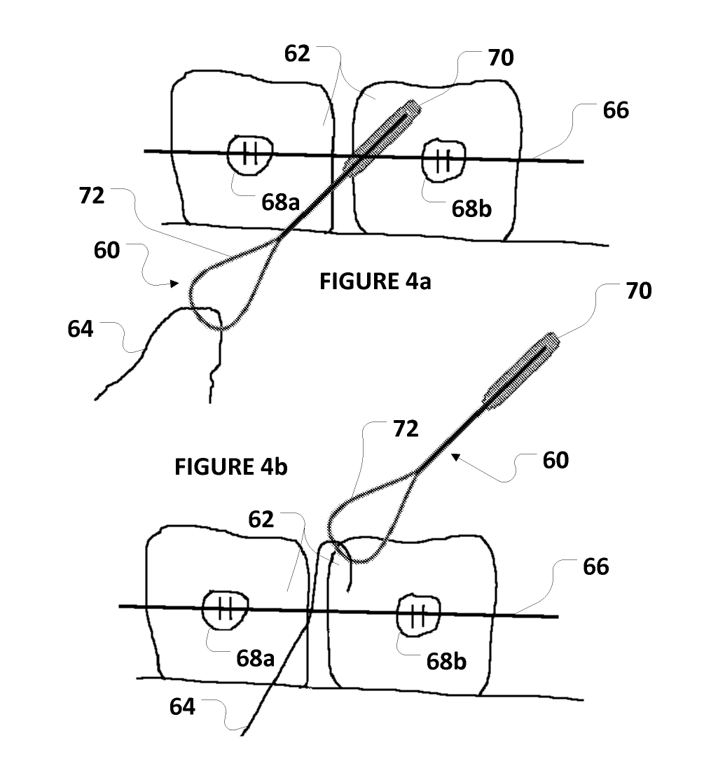

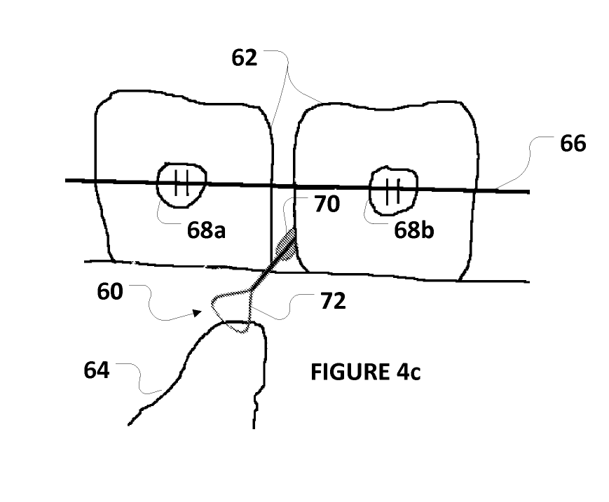

Turning now to FIGS. 4a and 4b demonstrating a method of use of the adapted floss threader. Shown is a small portion of the human mouth including two teeth 62 each containing a component of dental braces, bracket 68a and 68b with arch wire 66 extending therebetween. To begin using the adapted floss threader 60, the user inserts the covered end 70 through the space between the arch wire 66 and tooth 62 and threads dental floss 64 through the eyelet 72. The user then pulls the adapted floss threader 60 completely through the space between the arch wire 66 and tooth 62 but not so far that the dental floss 64 is pulled complete through. While one end of the dental floss 64 remains in the space between the arch wire 66 and the tooth 62 the user removes dental floss 64 from eyelet 72 and commences the flossing process.

Alternatively, FIG. 4c demonstrates a slightly different method of use of the adapted floss threader. Shown is a small portion of the human mouth including two teeth 62 each containing a component of dental braces, bracket 68a and 68b with arch wire 66 extending therebetween. To begin using the adapted floss threader 60, the user inserts the covered end 70 through the space between the teeth 62 and below arch wire 66 and threads dental floss 64 through the eyelet 72. The user then pulls the adapted floss threader 60 completely through the space between the teeth 62 but not so far that the dental floss 64 is pulled complete through. While one end of the dental floss 64 remains in the space between the teeth 62 the user removes dental floss 64 from eyelet 72 and commences the flossing process.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A dental floss threader adapted to minimize discomfort of the user comprising:
a shank extending between a first end and second and being elastically deformable;
an eyelet integrally joined at said first end of said shank; and
a covering enclosing said second end of said shank.

2. The threader of claim 1, wherein said covering covers less than half of the length of said shank.

3. The threader of claim 1, wherein said covering covers more than half of the length of said shank.

4. The threader of claim 1, wherein said covering is formed from silicone.

5. The threader of claim 1, wherein said covering is latex.

6. The threader of claim 1, wherein said covering is wax.

7. The threader of claim 1, wherein said covering has a diameter less than twice that of said shank.

8. The threader of claim 1, wherein said covering has a diameter more than twice that of said shank and less than six times that of said shank.

9. The threader of claim 1, wherein said covering defines a rounded tip.

10. The threader of claim 1, wherein said covering defines a rounded tip with a first diameter at said second end of said shank and an increasing diameter extending towards said first end of said shank.

11. The threader of claim 1, further including a coating on one or more of the surface of said eyelet, said shank, and said covering including one or more of wax, flavorants, colourants, and an antibacterial agent.

12. A process of manufacturing a dental floss threader, comprising:
providing a dental floss threader having a shank extending between a first end and second and being elastically deformable and an eyelet integrally joined at the first end of the shank; and
affixing a covering over the second end of the shank.

13. The process of claim 12 wherein said affixing is further defined as:
opening an injection mold comprising a molding cavity having a floss entrance hole and a gate;
placing into the mold cavity the second end of the shank wherein the second end extends into the molding cavity through the floss entrance hole;
closing the mold;
injecting material through the gate into the molding cavity and around the second end of the shank;
curing the molten material inside the molding cavity.

14. The process of claim 12 wherein said affixing is further defined as:
immersing the second end into a fluid bath;
removing the second end from the fluid bath; and
allowing the fluid on the second end to harden.

15. The process of claim 14 wherein said immersing is further defined as:
immersing the second end into the fluid bath more than once.

16. The process of claim 12 wherein the fluid bath contains molten fluid and said allowing further comprises cooling.

17. The process of claim 12 wherein the fluid bath contains a solvent containing fluid and said allowing further comprises evaporation of the solvent.

18. The process of claim 12 further comprising:
applying to the threader one or more of a wax, flavorants, colourants, and an antibacterial agent before said affixing.

19. The process of claim 12 further comprising:
applying to the threader one or more of a wax, flavorants, colorants, and an antibacterial agent after said affixing.

20. A method of using a dental floss threader set forth in claim 1 comprising:
passing the second end through a portion of a human mouth;
pulling dental floss through the eyelet a distance less than a length of the dental floss;
pulling the dental floss threader completely through the portion of the human mouth and the dental floss partially through the portion;
removing the dental floss from the eyelet;
flossing with the dental floss; and
removing the dental floss from the portion.
